(19) United States
(12) Patent Application Publication
(10) Pub. No.: US 2007/0277621 A1
(43) Pub. Date: Dec. 6, 2007

(54) Measuring Sensor

(75) Inventors: Werner Schlachter, Rossdorf (DE); Ursula Host, Weiterstadt (DE)

Correspondence Address: FASSE PATENT ATTORNEYS, P.A., P.O. BOX 726, HAMPDEN, ME, 04444-0726, US

(73) Assignee: Hottinger Baldwin Messtechnik GmbH, Darmstadt (DE)

(21) Appl. No.: 11/663,907

(22) PCT Filed: Sep. 20, 2005
(86) PCT No.: PCT/EP05/10099

§ 371 Date: Mar. 26, 2007

(30) Foreign Application Priority Data
Sep. 28, 2004 (DE) 10 2004 047 508.3

(51) Int. Cl. G01L 1/00

(52) U.S. Cl. 73/774

(57) ABSTRACT

The invention relates to a measuring sensor with a deformation body (7) on which at least one strain gage (2) is applied. In that regard, the strain gage (2) is hermetically sealed against external environmental influences by at least one thin deep drawn metallic sheet metal part (4). This hermetic sealing sheet metal part (4) is preferably embodied bowl-shaped and consists of a high-strength hardenable corrosion-resistant spring steel of the maraging type with 7.8 weight % nickel, 13 weight % chromium, 1 weight % molybdenum, 0.2 weight % silicon, 0.3 weight % manganese, 0.25 weight % beryllium, 0.2 weight % titanium as well as the remainder iron, which surprisingly comprises only a small hysteresis and has at least equally good creep characteristics as the stainless martensitic spring steels of the deformation body (7). Due to the good weldability of the maraging sheet metal part (4) with the martensite deformation body (7), there arises a surprising utilization for the hermetic sealing of the sensitive strain gages (2), which cause neither a significant force shunt nor a worsening of the physical measuring characteristics.

The invention relates to a hermetically sealed measuring sensor or transducer according to the preamble of the patent claim 1 as well as a use of a high-strength, hardenable, corrosion-resistant maraging spring steel according to the preamble of the patent claim 7 for the hermetic sealing of a measuring sensor.

Measuring sensors are mostly utilized for detecting a physical measured value and to convert this into a corresponding electrical signal. In that regard, often a force is detected as the physical measured value. A deformation body is impinged or acted on by this force, and strain gages are applied on the deformation body. The strain gages convert the force into a proportional electrical measurement signal through the resistance change caused by the strain. Such measuring sensors are used as force sensors, load cells, strain sensors, torque sensors, or pressure sensors, which are often arranged in damp spaces or must be exposed to other disadvantageous environmental influences.

At least with a longer time of influence, such environmental influences would impair the mechanical connection of the strain gage on the deformation body as well as the measurement technical characteristics of the strain gage, and thereby falsify the detected measured values or damage the sensor. For that reason, it has always been attempted to protect the strain gages applied on the deformation body relative to the environmental influences, in that the strain gages or the entire deformation body were enclosed in an air-tight manner. Thereby the problem often arose to arrange the seals so as not to cause force shunt effects that can falsify the measurement result. For that reason, some of the strain gages were encased or potted with elastomeric materials for which the force shunt effect was negligible, but which mostly did not protect against penetrating moisture over the long term.

Previously, the best protection against such environmental influences was offered only by metallic covers, which then had to be embodied, however, so that they would not cause any force shunt effects to the extent possible, or that these at least arose in a negligible order of magnitude. Thus, in connection with load cells or force sensors, partially the entire deformation body was surrounded by bellows-like metal pipe bodies and mostly welded to the force introduction and force output parts thereof. Through the bellows-like form and the most thin-walled possible metal embodiment, the force shunting effect was minimized, so that is was negligible for limited accuracy requirements. Such thin-walled encapsulations had the disadvantage, however, of being very sensitive to mechanical damages, and were also very complicated in the production and the application on the sensor parts.

A force sensor is known from the EP 0 307 998 A2, which consists of a rod-shaped deformation or upsetting body and is used as a load cell. In this force transducer, a through-going transverse bored hole is provided approximately in the middle of the longitudinally oriented rod-shaped upsetting body, and the bored hole is closed by two disk-shaped mutually opposite carrier plates. In that regard, the strain gages are applied on the inner sides of the carrier plates, whereby the carrier plates are welded or soldered with the outer shell surface of the upsetting body. Thereby, a hermetic sealing of the strain gages is achieved, whereby the sealing carrier plates act directly as deformation bodies, so that the force is detected directly in the force shunt branch. In that regard, it is provided that both the upsetting body as well the carrier plates consist of the same metal, so that a most homogeneous possible surface strain arises on the entire deformation body, whereby this strain is proportional to the weight load. However, grain changes also arise at the welded or soldered connections due to the thermal load, whereby these grain changes can lead to non-linearities on the deformation body, whereby the measuring accuracy is impaired. Moreover, a large part of the weight load is transmitted via the carrier plates, so that the weld or solder seams are relatively strongly loaded, and thus the durability and tightness of the seal is also dependent on the quality of the weld or solder connection.

A rod-shaped load cell with hermetically sealed strain gages is known from the EP 0 752 575 B1, in which the strain gages are applied directly on the rod-shaped deformation body. In that regard, pre-formed sheet metal covers are preferably used for the covering, whereby the sheet metal covers are directly welded at the rim on the rod-shaped deformation body, and comprise a radial spacing relative to the strain gages. In that regard, the strain gages are partially arranged in transverse bored holes of the axially embodied deformation body. For the hermetic sealing, bowl-shaped sheet metal covers are also provided, which are preferably connected in a hermetically tightly sealed manner with the circumference of the deformation body by a laser welding process. A significant force shunt influence is avoided by the radial spacing of the strain gages and the form or shape of the sheet metal covers. However, such rod-shaped load cells are preferably designed for larger loads and an upsetting or axial compressing loading of the deformation body, so that the influence of the cover, with a bowl-shaped embodiment and radial spacing, on the measurement result is relatively small.

With measuring sensors as bending beam sensors or with shear force structural configurations, especially with small rated load embodiments, the force shunt influence of such steel sheet metal covers would be considerably larger, so that only cover shapes with relatively steep and high bowl or sidewall parts are necessary therefor, in order to be as soft as possible in bending in the measurement force direction, so that the force shunt influence does not falsify the measurement result. Such sheet metal parts are, however, only economically producible as deep drawn parts, so that these previously were fabricated only of deep drawable austenitic stainless steel metal sheets. While such austenitic steels can be deep drawn well, they however have poor spring characteristics and thus worsen the creeping and the hysteresis in load cells, so that only measuring sensors with a relatively low accuracy class (according to OIML R60 C3, number of divisions or intervals ≦3000) were producible therewith. While hardenable martensitic sheet metals are known, these were previously either not deep drawable to the required extent for the required sheet metal thicknesses, or not sufficiently corrosion resistant.

Therefore it was the underlying object of the invention to provide a measuring sensor, of which the strain gages are durably protected against damaging environmental influences such as, especially, moisture. Simultaneously, the sealing means are to be producible in an economical manner, and are to be applyable on the deformation body in a simplest possible manner, and are not to significantly worsen the measurement accuracy.

This object is achieved by the invention set forth in the patent claims 1 and 7. Further developments and advantageous example embodiments of the invention are set forth in the dependent claims.

However, a high-strength hardenable martensitic spring steel was already known from the DE 100 01 650 A1, which was not only to be very corrosion resistant, but also was additionally to have an isotropic deformability. Only after practical tests or experiments with such a maraging spring steel, which is distributed by the company Vacuum-Schmelze of DE-63450 Hanau under the tradename MARVAC 125, it has been determined that this spring steel in a thin sheet metal form is not only deep drawable and corrosion resistant, but surprisingly also comprises a small creeping and has nearly the same good hysteresis characteristics as there are to be found in the high quality deformation bodies of special non-deep-drawable stainless high grade steel.

Through the inventive use of such a maraging spring steel, it was advantageously possible to deep draw sheet metal parts for the covering of strain gages, which parts comprise only very small bending radii, and which could be embodied with a small ratio of the deep drawing height to the sheet metal part diameter, and that are nearly comparable to the values of austenitic steels. In that regard, after a relatively short hardening time of approximately two hours at 470° C., high tensile strengths (>2000 N/mm²) with a large Vickers hardness (HV of >600) were achievable, which ensure optimal spring characteristics. Thereby very small hysteresis values were achieved, which did not lie above those of the deformation body, whereby advantageously the measurement accuracy of the sensor was not worsened at least by the metallic covering.

Simultaneously, only a small increase of the positive creeping effect was determined or effectuated by the advantageous metallic sheet metal covering, whereby this positive creeping effect was still compensatable in a simple manner by the negative creep characteristic of the strain gages, so that a negligible force shunt effect arose due to the thin sheet metal covering and the hard spring steel characteristic with high deep drawing ability. Thereby it advantageously became possible to produce hermetically sealed measured value sensors with very high accuracy values, such as for example load cells with an accuracy class C6 according to OIML R60 and a number of divisions or intervals n_{LC}=6000.

The invention furthermore has the advantage that the utilized high-strength hardenable maraging spring steel has a high corrosion resistance and good laser weldability, so that a durable hermetically sealed encapsulation of the sensitive strain gages is achievable in a simple manner, and this surprisingly with only the smallest negative measurement technical influence. In that regard, especially with very thin-walled sheet metal part coverings of preferably 0.1 mm, mechanical stabilities have been achieved, which are only achievable with substantially greater sheet metal thicknesses with austenitic steels, and thus advantageously also offer a high mechanical protection against external influence.

The invention is explained more closely in connection with an example embodiment, which is illustrated in the drawing, wherein:

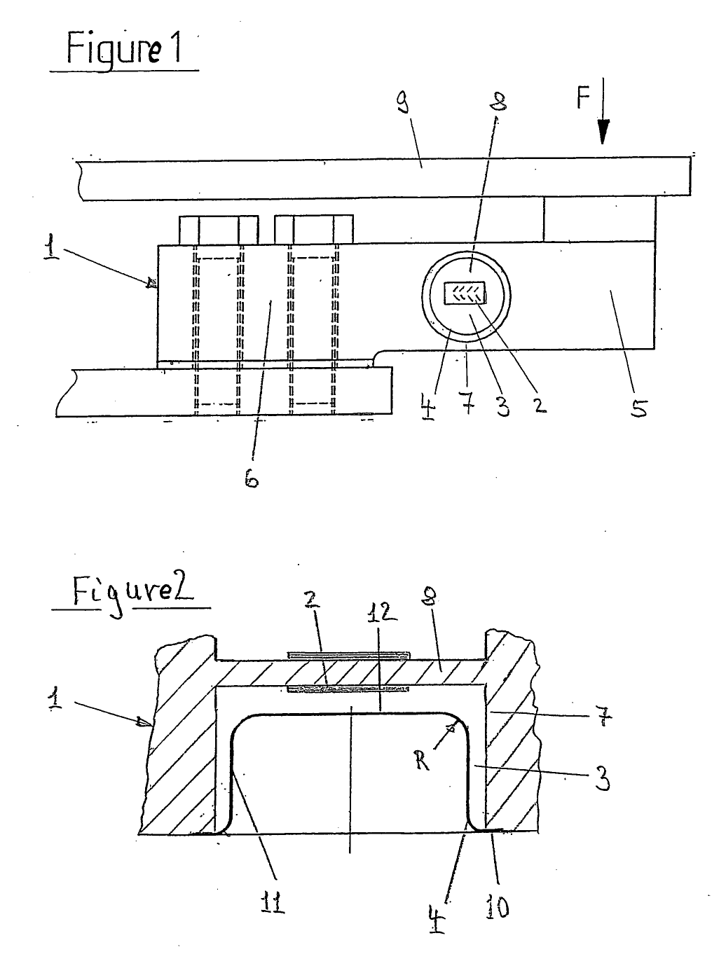

FIG. 1 shows a side view of a bending beam sensor or transducer, and

FIG. 2 shows an enlarged cut-out portion in a top plan view onto a hermetically sealed strain gage.

In FIG. 1 of the drawing, there is illustrated a measuring sensor or transducer in the form of a bending beam sensor or transducer 1, which comprises two strain gages 2 in two oppositely directed bored holes 3, which are hermetically sealed with the aid of bowl-shaped sheet metal parts 4 of a special high-strength hardenable corrosion-resistant spring steel of the maraging type.

The bending beam sensor 1 consists of a force introduction part 5 on which a weighing platform 9 is secured, and a fixedly clamped-in force receiving part 6. A deformation body 7 is arranged between the force introduction part 5 and the force receiving part 6, whereby the deformation body 7 is essentially formed of two oppositely directed bored holes 3, between which a vertical intermediate wall 8 remains, on which strain gages 2 in the form of shear force sensors or transducers are applied on each side. The arrangement of the two strain gages 2 in the oppositely directed bored holes 3 can be seen in detail from the sectional view in FIG. 2 of the drawing.

The bending beam sensor 1 is embodied in a right-angled manner, and is preferably utilized as a load cell for weight determination. The bending beam is embodied as one piece and preferably consists of a special high-strength hardenable corrosion-resistant martensitic spring steel, which was produced by chip-removing machining, and which comprises only a small hysteresis and only small creeping behavior especially for measuring technical purposes. Therefore, very accurate force and weight measurements can be carried out with such measuring sensors. Such measuring sensors with strain gages 2 on corresponding force-impingable deformation bodies 7 are also producible in other embodiment variants, and can also be utilized for the torque measurement, pressure measurement, and strain measurement or other force-relevant measurements.

The illustrated force sensor or load cell contains strain gages 2 in the form of shear force sensors, that are applied on the vertical intermediate wall 8 and are thus provided within a bored hole 3. These strain gages 2 are hermetically sealed according to the invention by a bowl-shaped sheet metal part 4 of a special maraging steel, which extends into the bored hole 3 and is welded all the way around its outer rim 10 with the deformation body 7, which preferably is achieved automatically with the aid of a laser welding apparatus.

The bowl-shaped sheet metal part 4 is produced by a deep drawing process and consists of a maraging spring steel that is known from the DE 100 01 650 A1, and that is produced and distributed under the tradename MARVAC 125 by the company Vacuumschmelze GmbH of D-63460 Hanau. This maraging steel preferably consists of an alloy with 7.8 weight % nickel, 13 weight % chromium, 1 weight % molybdenum, 0.2 weight % silicon, 0.3 weight % manganese, 0.25 weight % beryllium, 0.2 weight % titanium as well as the remainder iron, and is hardenable after the deep drawing process, whereby excellent values with respect to hysteresis and creep characteristics result for the formed sheet metal part 4, which characteristics first make possible a utilization for the application for such high accuracy measured value sensors or transducers. Since these sheet metal parts 4 also still have a good corrosion resistance and good welding characteristics, they are suitable for a durable sealing of sensitive strain gages 2.

The bowl-shaped sheet metal part 4 is produced by deep drawing from a thin maraging steel metal sheet of preferably 0.1 mm thickness. In that regard, the illustrated embodiment for a bending beam load cell has a round diameter of approximately 20 mm for a depth of approximately 10 mm, that is inserted into a 25 mm bored hole. The bowl-shaped sheet metal part 4 has an outer rim 19 that is outwardly beaded or flanged-over at a right angle, and that lies in contact on the outer rim of the deformation body 7 and is automatically weldable with this all the way around. Due to the isotropic structure of the maraging metal sheet, sheet metal parts with small bending radii R≧1 mm are deep drawable, so that bowl-like sheet metal parts 4 with sidewall surfaces 11 and floor or bottom wall surfaces 12 standing perpendicularly on one another can be produced, which are relatively soft to bending in connection with a loading of the bending beam sensor 1 in the bending direction thereof, so that a force shunting effect that falsifies measured values basically hardly arises.

Such bowl-shaped sheet metal parts 4 for the hermetic sealing of strain gages 2 on measuring sensors are not only applyable within bored holes 3, but rather are also suitable, oriented toward the outside, for the covering of strain gages 2 on planar outer wall surfaces. Such bowl-shapes also need not be embodied round, but rather are basically also producible in an angular or cornered shape embodiment due to the good deep drawing ability. Thereby, the sidewall parts 11 that are deformable upon loading can also be embodied in a corrugated form, in order to still reduce the small force shunting effect. Due to the good deep drawing ability, inwardly directed bowl-shaped embodiments are producible both with round as well as with angular or cornered embodiments, as they are necessary for double bending beam sensors with double bored holes, for example.

1. Measuring sensor with a deformation body (7), on which at least one strain gage (2) is applied, whereby the strain gage (2) is hermetically sealed against external environmental influences by at least one thin deep-drawn metallic sheet metal part (4), characterized in that the sheet metal part (4) consists of a high-strength hardenable corrosion-resistant spring steel of the maraging type, which essentially consists of 6 to 9 weight % nickel, 11 to 15 weight % chromium, 0.1 to 0.3 weight % titanium, 0.2 to 0.3 weight % beryllium, and the remainder iron, whereby the spring steel comprises a martensite temperature M_{S}≧130° C. and the ferrite content of the spring steel amounts to C_{Ferrite}<3%.

2. Measuring sensor according to claim 1, characterized in that the metallic sheet metal part (4) is embodied bowl-shaped round or polygonal and comprises a sheet metal thickness of 0.05 to 0.5 mm.

3-6. (canceled)

7. Use of a high-strength hardenable corrosion-resistant spring steel of the maraging type, with isotropic deformability, which essentially consists of 6 to 9 weight % nickel, 11 to 15 weight % chromium, 0.1 to 0.3 weight % titanium, 0.2 to 0.3 weight % beryllium and the remainder iron, whereby the spring steel comprises a martensite temperature M_{S}≧130° C. and the spring steel has a ferrite content C_{Ferrite}<3%, characterized in that the spring steel is provided as a thin deep drawn sheet metal part (4) for the sealing of strain gages (2) on deformation bodies (7) of a measuring sensor (1) for the protection against environmental influences.

8. Measuring sensor according to claim 1, characterized in that the bowl-shaped sheet metal part (4) contains a planar outer rim (10) that protrudes at a right angle or an obtuse angle relative to the bowl-shaped sidewalls (11), with which outer rim the sheet metal part (4) is welded all the way around with the deformation body (7), whereby the sheet metal part (4) with its sidewalls (11) and floor wall surfaces (12) is arranged both recessed or let inwardly into a bored hole (3) or recess or facing outwardly from the deformation body (7).

9. Measuring sensor according to claim 1, characterized in that the sidewalls (11) and the floor wall surface (12) of the bowl-shaped sheet metal parts (4) stand on one another at an obtuse angle to a right angle and comprise connection radii (R) of 1 mm to 10 mm.

10. Measuring sensor according to claim 1, characterized in that the bowl-shaped sheet metal part (4) is embodied by one or more deep drawing process stages so that the ratio of bowl depth to bowl diameter or bowl diagonal is a ratio of 1:1.5 or greater.

11. Measuring sensor according to claim 1, characterized in that the deep drawn sheet metal parts (4) consist of smooth electropolished or corrugated wall parts (11, 12).
